(19) United States
(12) Patent Application Publication
(10) Pub. No.: US 2026/0042222 A1
(43) Pub. Date: Feb. 12, 2026

(54) ROBOT FOR PROVIDING CUSTOMIZED SERVICE AND METHOD THEREOF

(71) Applicant: ROBOCARE CO., LTD., Seongnam-si (KR)

(72) Inventors: Deok-Won LEE, Seongnam-si (KR); Kooksung JUN, Incheon (KR)

(21) Appl. No.: 19/362,640

(22) Filed: Oct. 20, 2025

Related U.S. Application Data
(63) Continuation of application No. PCT/KR2023/018410, filed on Nov. 16, 2023.

(30) Foreign Application Priority Data
May 8, 2023 (KR) 10-2023-0059337

(51) Int. Cl. B25J 9/16; B25J 5/00; B25J 11/00; B25J 19/02

(52) U.S. Cl. CPC B25J 9/1697; B25J 5/007; B25J 9/161; B25J 11/008; B25J 19/023

(57) ABSTRACT

A customized service providing robot according to an embodiment of the present disclosure includes: a moving device configured to move the robot to a location where a user is recognized; a collection device configured to capture an image of the user through a visual sensor and collect imaging information; and a processor configured to process the information collected by the collection device and control the moving device, and the processor inputs the information collected through the collection device into at least one pre-trained analysis model to derive element information for each analysis model (a), integrates the derived element information for each analysis model to generate integrated information and recognizes the user's current situation based on the integrated information to generate situation information (b), and provides a customized service to the user based on the situation information (c).

### TECHNICAL FIELD

The present disclosure relates to a robot for providing customized service to a user and a method for providing the customized service using the robot.

### BACKGROUND

Recently, the goal of robot development has been redirected from creating mechanical computing devices to designing pet robots that are closely related to and deeply integrated into human lives. Such a pet robot is called an interactive robot as it interacts with human beings.

However, most interactions performed by currently available interactive robots, such as smart speakers or toy robots, are simple and passive actions that involve receiving input from a user and outputting a corresponding response. Therefore, it is difficult for these robots to recognize the user's situation and actively provide an appropriate service to the user. Since they are viewed as simple computing devices, it is increasingly important to differentiate them.

In particular, elderly individuals who spend long hours at home often face health issues and limitations in daily activities due to aging. In such situations, home care is typically provided by family members or caregivers, but continuous care for the elderly in all circumstances requires a significant amount of time and cost.

However, as described above, currently developed robots have difficulty accurately recognizing the situation of the user in need of care.

Although care-oriented robots currently in development may offer services such as voice guidance, emergency support, and media playback, these services are mostly provided only when the user inputs a desired service. Therefore, it remains challenging for robots to actively recognize the user's situation and provide an appropriate service.

### DISCLOSURE OF THE INVENTION

### Problems to be Solved by the Invention

The present disclosure is conceived to provide a robot and method for providing a customized service to accurately recognize a user's situation in an active manner and provide a service corresponding to the user's situation.

Further, the present disclosure is conceived to provide a robot and method for providing a customized service to more accurately recognize a user's situation and enhance the usability of the robot for the user by using not only visual information but also various types of sensing data.

Furthermore, the present disclosure is conceived to provide a robot and method for providing a customized service to reduce the likelihood of misrecognizing a user's situation by varying the determination criteria based on the state and type of the collected information.

However, the problems to be solved by the present disclosure are not limited to the above-described problems. There may be other problems to be solved by the present disclosure.

### Means for Solving the Problems

As a means for achieving the above-described technical problems, an aspect of the present disclosure provides a robot for providing a user customized service that includes: a moving device configured to move the robot to a location where a user is recognized; a collection device configured to capture an image of the user through a visual sensor and collect imaging information; and a processor configured to process the information collected by the collection device and control the moving device, and the processor inputs the information collected through the collection device into at least one pre-trained analysis model to derive element information for each analysis model (a), integrates the derived element information for each analysis model to generate integrated information and recognizes the user's current situation based on the integrated information to generate situation information (b), and controls the robot to provide a customized service to the user based on the situation information (c).

The above-described aspects are provided by way of illustration only and should not be construed as limiting the present disclosure. Besides the above-described embodiments, there may be additional embodiments described in the accompanying drawings and the detailed description.

### Effects of the Invention

According to any one of the above-described means for solving the problems of the present disclosure, it is possible for a robot to actively and accurately recognize a user's situation and provide a service corresponding to the user's situation.

Further, it is possible for a robot to more accurately recognize a user's situation and enhance the usability of the robot for the user by using not only visual information but also various types of sensing data.

Furthermore, it is possible to reduce the likelihood of misrecognizing a user's situation by varying the determination criteria based on the state and type of the collected information.

### BRIEF DESCRIPTION OF THE DRAWINGS

FIG. 1 is a configuration view of a customized service providing system according to an embodiment of the present disclosure.

FIG. 2 is a configuration view of a customized service providing robot according to an embodiment of the present disclosure.

FIG. 3 to FIG. 10, FIG. 11A to FIG. 11B are diagrams illustrating analysis models configured to analyze imaging information in a customized service providing robot according to an embodiment of the present disclosure.

FIG. 12 is a diagram illustrating the process by which the customized service providing robot recognizes a situation according to an embodiment of the present disclosure.

FIG. 13 and FIG. 14 are diagrams illustrating the provision of customized services by the customized service providing robot according to an embodiment of the present disclosure.

FIG. 15 and FIG. 16 are diagrams illustrating the generation of situation information by a situation recognition unit based on a rule-based model according to an embodiment of the present disclosure.

FIG. 17 and FIG. 18 are diagrams illustrating the generation of situation information by the situation recognition unit based on a machine learning model according to an embodiment of the present disclosure.

FIG. 19 is a diagram illustrating the generation of situation information by the situation recognition unit based on both the rule-based model and the machine learning model according to an embodiment of the present disclosure.

FIG. 20 is a diagram illustrating the provision of a customized service by the customized service providing robot according to an embodiment of the present disclosure.

FIG. 21 is a flowchart showing a method for providing a customized service according to an embodiment of the present disclosure.

### BEST MODE FOR CARRYING OUT THE INVENTION

Hereinafter, example embodiments will be described in detail with reference to the accompanying drawings so that the present disclosure may be readily implemented by those skilled in the art. However, it is to be noted that the present disclosure is not limited to the example embodiments but can be embodied in various other ways. In the drawings, parts irrelevant to the description are omitted for the simplicity of explanation, and like reference numerals denote like parts through the whole document.

Throughout this document, the term “connected to” may be used to designate a connection or coupling of one element to another element and includes both an element being “directly connected” another element and an element being “electronically connected” to another element via another element. Further, it is to be understood that the terms “comprises,” “includes,” “comprising,” and/or “including” means that one or more other components, steps, operations, and/or elements are not excluded from the described and recited systems, devices, apparatuses, and methods unless context dictates otherwise; and is not intended to preclude the possibility that one or more other components, steps, operations, parts, or combinations thereof may exist or may be added.

Throughout this document, the term “unit” may refer to a unit implemented by hardware, software, and/or a combination thereof. As examples only, one unit may be implemented by two or more pieces of hardware or two or more units may be implemented by one piece of hardware.

Throughout this document, a part of an operation or function described as being carried out by a terminal or device may be implemented or executed by a device connected to the terminal or device. Likewise, a part of an operation or function described as being implemented or executed by a device may be so implemented or executed by a terminal or device connected to the device.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality.

Processors are considered processing circuitry or circuitry as they include transistors and other circuitry therein. In the disclosure, the circuitry, units, or means are hardware that carry out or are programmed to perform the recited functionality.

The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

Hereinafter, embodiments of the present disclosure will be described in detail with reference to the accompanying drawings.

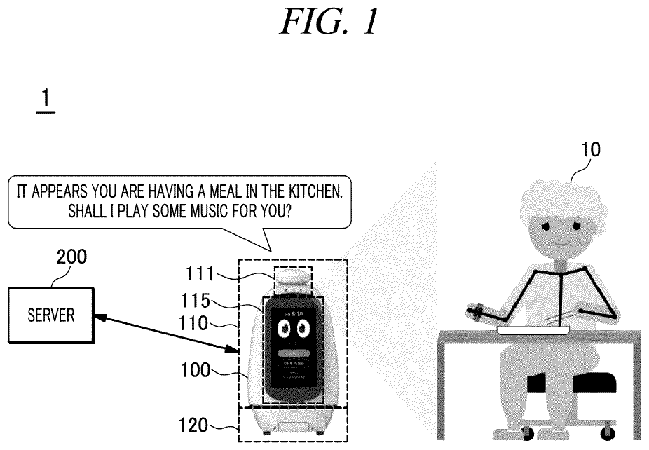

FIG. 1 is a configuration view of a customized service providing system according to an embodiment of the present disclosure.

Referring to FIG. 1, a customized service providing system 1 may include a customized service providing robot 100.

The components of the customized service providing robot 100 illustrated in FIG. 1 are typically connected to each other via a network. For example, as illustrated in FIG. 1, the customized service providing robot 100 and a server 200 may be connected to the network simultaneously or with a time interval. The network refers to a connection structure that enables information exchange between nodes, such as devices and servers, and includes LAN (Local Area Network), WAN (Wide Area Network), Internet (WWW: World Wide Web), a wired or wireless data communication network, a telecommunication network, a wired or wireless television network, and the like. Examples of the wireless data communication network may include 3G, 4G, 5G, 3GPP (3rd Generation Partnership Project), LTE (Long Term Evolution), WIMAX (World Interoperability for Microwave Access), Wi-Fi, Bluetooth communication, infrared communication, ultrasonic communication, VLC (Visible Light Communication), LiFi, and the like, but may not be limited thereto.

The customized service providing robot 100 may operate based on an internal power supply or an external power supply, and can be exemplified as a robot designed to interact and engage with a user 10. More specifically, the customized service providing robot 100 may include a body unit 110 and a moving device 120, and may further include additional components necessary for driving the robot.

The body unit 110 may serve as a main structure of the customized service providing robot 100, in which key components such as a processor 112, a battery (not shown), and a communication device 118 are installed internally, or to which other components are externally connected. The body unit 110 may further include a collection device 111 for capturing an image of the user or sensing the user's voice or surrounding sounds to generate related information, a display 116 for outputting images or text, and a speaker 117 for outputting voice.

The collection device 111 may capture an image of the user 10 or the environment around the user using a visual sensor such as a camera. Examples of the visual sensor may include imaging devices such as a camera that generates general RGB pixel data, an infrared camera for capturing images in dark environments, and a depth camera capable of generating depth information about the distance to a target object.

Further, the collection device 111 may receive a user 10's voice or surrounding sounds through a sound sensor such as a microphone. Since the user's voice or surrounding sounds are important inputs in interaction with the user, it is desirable to place the microphone where there is no obstruction to receive these sounds. For example, if the microphone is placed directly behind a speaker hole on the front of the body unit 110, it can directly receive the user's voice and surrounding sounds.

Meanwhile, the microphone may not be a separate component from the speaker, but may instead be integrated with the speaker. In this case, the above-described positioning considerations for the microphone may not be necessary, which can improve internal space utilization within the body unit 110.

Furthermore, the collection device 111 may receive device information generated by other smart devices through a communication unit, which will be described later in more detail.

Moreover, the collection device 111 may include one or more sensors configured to detect at least one of the following: internal information of the customized service providing robot 100 (particularly its operational status), environmental information, location information, and user information.

For example, the collection device 111 may include a proximity sensor, a laser scanner (LiDAR sensor), an RGBD sensor, a geomagnetic sensor, an ultrasonic sensor, an inertial sensor, and a UWB sensor in addition to the sensors described above.

The display 116 serves as a type of liquid crystal display, and may output one or more of text, an image, or a video containing predetermined information. Herein, the predetermined information may include status information of the customized service providing robot 100, such as communication signal strength information, remaining battery information, or wireless Internet ON/OFF information. The display 116 may present media content corresponding to situation information recognized by the customized service providing robot 100, or may display voice output by the customized service providing robot 100 through the speaker in text form. For example, based on situation recognition, the customized service providing robot 100 may set a wake-up alarm and display text such as “Wake-up at 7:00 AM”on the display 116.

The display 116 may display text by repeating a single type of information described above, by alternating between a plurality of types, or by displaying specific information by default. For example, status information of the customized service providing robot 100 such as communication signal strength information, remaining battery information, or wireless Internet ON/OFF information may be continuously displayed as small text at the top or bottom of the display 116, while other types of information may be alternately displayed.

As described above, the display 116 may output one or more of images or videos. In this case, to enhance visibility, it is preferable for the display 116 to be implemented as a large, high-resolution liquid crystal display, rather than one that only outputs text. The display 116 shown in FIG. 1 should be regarded as merely illustrative.

The speaker 117 may output various sounds including voice. Herein, the voice is auditory information output by the customized service providing robot 100 for interaction with the user. The type of voice can be set by using a media-specific application installed on the user's device (not shown) or by directly controlling the customized service providing robot 100.

For example, the type of voice output through the speaker 117 may be selected from various voices, such as a male voice, a female voice, an adult's voice, and a child's voice, and the language may also be selected, such as Korean, English, Japanese, and French.

The speaker 117 not only outputs voice but also functions as a typical speaker for general sound output. For example, if the user wants to listen to music through the customized service providing robot 100, the music may be output through the speaker 117. If a video is displayed on the display 116, sound synchronized with the video may be output through the speaker 117.

The moving device 120 can move the customized service providing robot 100. More specifically, the moving device 120 can move the robot's body unit 110 within a specific space, in response to a move command from a control device. More specifically, the moving device is equipped with a motor and a plurality of wheels that work together to drive, redirect, and rotate the customized service providing robot 100.

The body unit 110 and the moving device 120 perform their functions in response to a control signal from the processor 112 in the body unit. For the convenience of explanation, these functions will be described as being performed by the customized service providing robot 100.

Hereinafter, each component of the customized service providing robot 100 will be described.

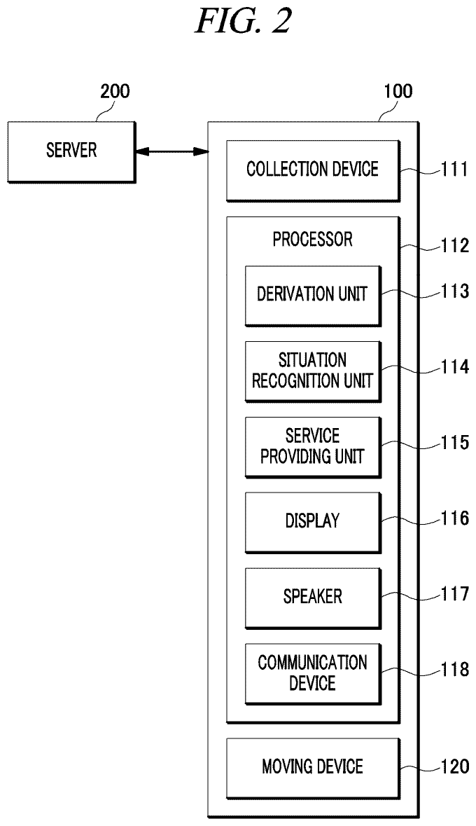

FIG. 2 is a configuration view of the customized service providing robot 100 according to an embodiment of the present disclosure. Referring to FIG. 2, the customized service providing robot 100 may include the body unit 110 and the moving device 120. Herein, the body unit 110 may include the collection device 111, the processor 112, the display 116, the speaker 117, the communication device 118, and a database 119.

The processor 112 may also include a derivation unit 113, a situation recognition unit 114, and a service providing unit 115 to perform data processing of the processor 112. Hereinafter, the operations of the derivation unit 113, the situation recognition unit 114, and the service providing unit 115 will be defined as being performed by the processor 112.

The collection device 111 may collect imaging information of the user through the visual sensor. As described above with respect to FIG. 1, the collection device 111 may include various sensors to collect information about the user's surrounding environment, and a camera may be a type of visual sensor.

The body unit 110 may be rotated or moved through the moving device 120 to face the direction of the user. Accordingly, the collection device 111 may generate imaging information by capturing an image of the user with the camera. Further, the camera of the collection device 111 may be equipped with a control device for controlling a capture direction of the camera. Thus, it is possible to capture the user's entire body or to better frame the user's face by controlling the vertical or horizontal orientation of the camera.

The imaging information may be visual data such as images or videos of the user. The imaging information may also include the user's body and objects or background around the user, and may be used later to analyze the user's situation.

The collection device 111 may further collect at least one of information: time information for the capture of the imaging information, robot location information generated by recognizing the location of the robot through a location sensor, sound information generated by recognizing the user's voice or surrounding sounds through a sound sensor, and device information generated from another smart device.

Particularly, the device information can be obtained from the smart device by detecting its location and connecting to it when necessary. The customized service providing robot 100 can control the moving device 120 to move toward the user based on the device information.

The smart device may be the user's smartphone, smartwatch, or wearable device. The smart device may contain information about the user, and may also refer to a monitoring device used to monitor the user.

The smart device may be usually worn or carried by the user or located at a close distance to the user, and may generate information about the location of the smart device by using GPS or short-range wireless signals. Therefore, when the customized service providing robot 100 receives location information or signals from a mutually authenticated or connected smart device, it can identify the location of the user more quickly and easily. Accordingly, the smart device can control the moving device 120 to find the user.

Further, the device information may be generated by the smart device by detecting a movement of the smart device. The derivation unit 113 and the situation recognition unit 114 may generate situation information based on element information and the device information.

The smart device may be equipped with a gyro sensor or a proximity sensor to generate movement information based on the user's movement. The movement information may be used to detect the user's sudden fall, change in pose, or abnormal activity. Further, the movement information may be generated by the smart device based on the user's movement, particularly when the user remains still for a long time or moves at a constant speed or in a fixed direction. That is, the above-described movement information may include information about the user's fast movements, stationary state, or movement at a constant speed or in a fixed direction.

The situation recognition unit 114, which will be described later, may use the above-described movement information to determine whether the user is in an emergency situation.

Further, the smart device may be a wearable device attached to or worn by the user. In this case, the smart device may collect various bio-data from the user, such as heart rate, respiration, body temperature, sleep status, blood sugar, blood pressure, stress level, or dietary status. The bio-data generated by the smart device may be provided to the customized service providing robot 100 in a wired or wireless manner.

The customized service providing robot 100 may use the received bio-data as data to determine the user's situation. For example, when the user's heart rate or respiration is abnormal, the customized service providing robot 100 may determine that the user's situation is critical while generating situation information, which will be described later. The derivation unit 113 may input the information collected by the collection device 111 into at least one analysis model and derive element information for each analysis model. As described above, the collection device 111 may collect imaging information of the user, sound information of the user or the surrounding environment, the user's location information, and device information through at least one built-in sensor. The collected information may be provided to the analysis model of the derivation unit 113.

The derivation unit 113 may use at least one analysis model. Each pre-trained analysis model may be stored in the database 119. The derivation unit 113 may analyze the determined input data, input it into one or more of the analysis models, and derive a predetermined output data from each analysis model. The output data from each analysis model may then be used as element information that composes integrated information.

More specifically, the analysis model may include at least one of a space classification model for determining the type of space in an image included in the imaging information, an object detection model for determining the location and type of an object in an image included in the imaging information, and an action recognition model for determining the user's pose in an image included in the imaging information.

Further, the analysis model may include a face detection model for detecting the user's face in an image included in the imaging information and determining the location of the face.

Furthermore, the analysis model may include at least one of an identity recognition model for recognizing the user's identity from a face image generated based on the determined location of the face, a facial expression recognition model for recognizing the user's facial expression from a face image generated based on the determined location of the face, and a face orientation recognition model for recognizing the user's face orientation from a face image generated based on the determined location of the face.

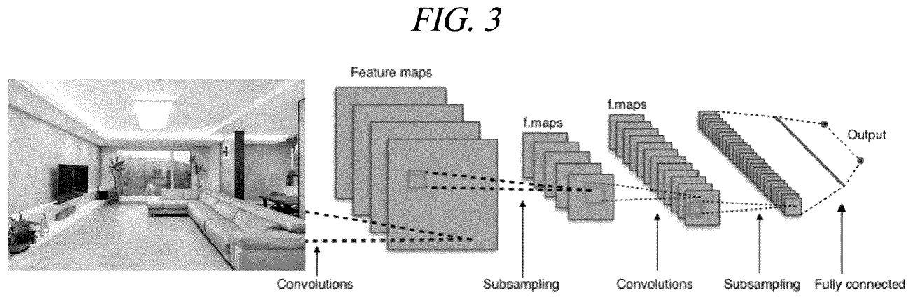

Hereinafter, each analysis model will be described in more detail with reference to FIG. 3 to FIG. 10, FIG. 11A to FIG. 11B.

FIG. 3 is a diagram illustrating the space classification model, which is one of the analysis models used by the derivation unit 113. The space classification model may use a well-known Convolutional Neural Network (CNN)-based classification model. To this end, CNN architectures such as AlexNet, VGG-16, Inception, ResNet, and MobileNet may be used.

As shown in FIG. 3, the space classification model extracts feature maps containing features within an image by repeating convolutional operations and sub-sampling operations, and finally outputs a score vector for the space via a fully connected layer. A space with the highest score among pre-set spaces can be considered the final recognized space by the space classification model.

The space classification model can output space classes such as a living room, a kitchen, a master bedroom, and a veranda. When the derivation unit 113 applies the input imaging information to the space classification model and the score for the living room is the highest, the derivation unit 113 may generate element information with a result value indicating that the user's current space is the living room.

To improve the accuracy of space classification through the space classification model, when the robot draws a map of the space where the user is located during the training of the space classification model, information about the space and a captured image can be used together for training.

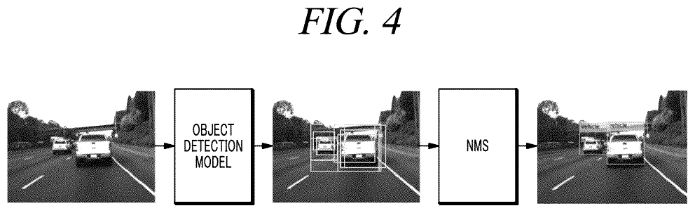

FIG. 4 is a diagram illustrating the object detection model, which is one of the analysis models used by the derivation unit 113. The object detection model may use a CNN-based classification model to output a bounding box indicating the type and location of the detected object. To this end, CNN architectures such as AlexNet, VGG-16, Inception, ResNet, and MobileNet may be used. Representative object detection models may include RCNN, Fast RCNN, YOLO, Single Shot Detector (SSD), Retina-Net, and Pyramid Net.

As shown in FIG. 4, the object detection model may generate a plurality of bounding boxes for the objects located within an image by performing convolutional operations. Then, the object detection model may apply a Non-Maximum Suppression (NMS) operation to the plurality of bounding boxes and images to derive a final bounding box by retaining the one with the highest score. Thereafter, the object detection model may analyze the features of the object within the bounding box to determine the type of object. FIG. 4 illustrates an example of a process of the object detection model. When an image input into the object detection model includes a plurality of vehicles driving on a road, the object detection model generates bounding boxes for the vehicles, recognizes the objects as vehicles, and finally outputs result values such as the types and reliability of the object, and the locations and sizes of their bounding boxes.

To improve the accuracy of the results, the object detection model may be trained to output only objects likely to be within the robot's range of action. For example, for a robot's range of action is limited to a house, the object detection model may be trained to recognize only certain types of objects, such as people, vacuum cleaners, TVs, and beds.

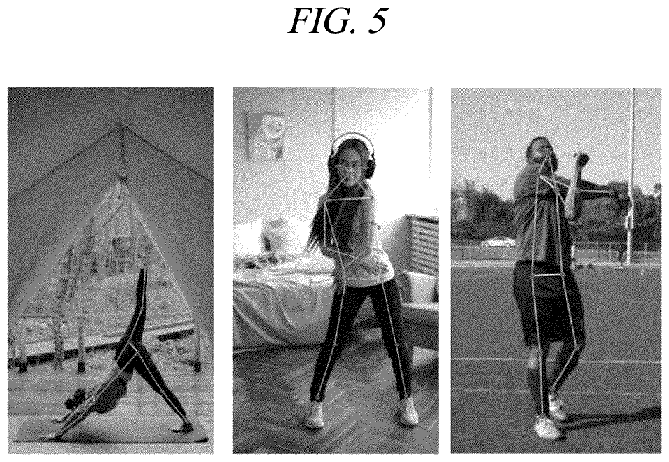

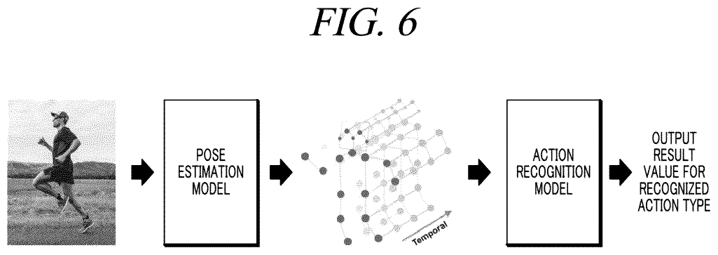

FIG. 5 and FIG. 6 are diagrams illustrating the action recognition model for determining the user's pose in an image included in the imaging information. The process of recognizing the user's pose needs to precede the recognition of the user's action. Thus, a pose estimation model will be described first with reference to FIG. 5. For pose estimation, a CNN-based pose estimation algorithm may be used for 2D or 3D images to estimate 2D/3D pose information. As the pose estimation model, a CNN-based feature point detection model may be applied, and algorithms, such as MoveNet, PoseNet, OpenPose, MediaPipe, AlphaPose, Nuitrack, and Kinect SDK, may be used. A CNN-based feature point detection model can be applied as the pose estimation model, and algorithms such as MoveNet, PoseNet, OpenPose, MediaPipe, AlphaPose, Nuitrack, and Kinect SDK can be used. Pose information and the values calculated from it do not change over short periods and can be effectively used to identify a tracking target.

Referring to FIG. 5, the pose estimation model receives 2D or 3D images and estimates 2D or 3D coordinates and their reliability for each joint. In this case, the estimated joint data may be represented as a graph in which body parts, such as the head, shoulders, chest, arms, hips, and legs, are nodes and each node is connected by an edge.

To improve the accuracy of the results, the pose estimation model may select either a model that estimates a single person's pose or one that estimates many people's poses, depending on the type of service provided by the robot, in order to extract joint data. For a one-to-one service, the robot may use a model that estimates a single person's pose. Conversely, for services to many people in the house, it may use a model that estimates many people's poses. Further, the pose estimation model may select a single-person or multi-person version depending on the number of people detected by the object detection model.

FIG. 6 is a diagram illustrating the action recognition model for analyzing the type of action based on the joint data generated by the pose estimation model.

When an input image or video is input into an artificial intelligence (AI) model without preprocessing, the processing speed is slow due to the large size of the data to be processed. Therefore, it is desirable to apply the pose estimation model to the input image to extract joint data as described above and then recognize the type of action based on the extracted joint data.

The action recognition model may recognize actions by using the 2D/3D pose information extracted from 2D/3D images by the pose estimation model. In this case, the action recognition model may use a rule-based method, such as a threshold-based method, to classify actions. Alternatively, the action recognition model may use a machine learning-based method such as a Recurrent Neural Network (RNN), which is a powerful neural network for processing time-series data and suitable for action recognition based on time-series pose information, or a Graph Convolutional Network (GCN), which uses the graph structure of pose data.

As shown in FIG. 6, the pose estimation model extracts joint data from an input image which is then used by the action recognition model based on pose information to recognize the action of the person in the image.

To improve the accuracy of the results, the action extraction model may be limited in the types of actions that can be recognized. For example, the action extraction model may be limited to recognizing only actions that are mainly performed inside the house.

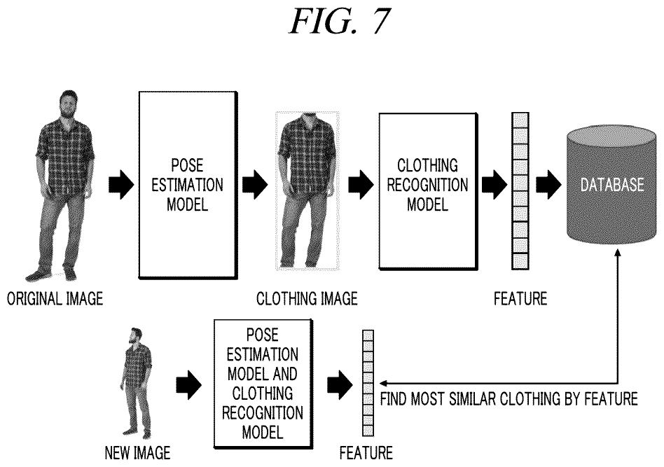

FIG. 7 is a diagram illustrating a clothing recognition model for analyzing the type of clothing based on the joint data generated by the pose estimation model.

Since the locations of a person's shoulders and ankles in the image can be identified using the joint data obtained through the pose estimation model, it is possible to crop out images of the top and bottom worn by the person. The clothing recognition model may use a CNN-based model to convert clothing information into data and extract its features.

Referring to FIG. 7, the pose estimation model is applied to an image of a person to extract joint data, which is then input into the clothing recognition model to extract its features, and the extracted features are stored in the database 119. Thereafter, when a new image is input, features are extracted by applying the above-described pose estimation model and clothing recognition model. The extracted features are compared and matched with the features stored in the database 119 to recognize the image containing the person wearing the same clothing

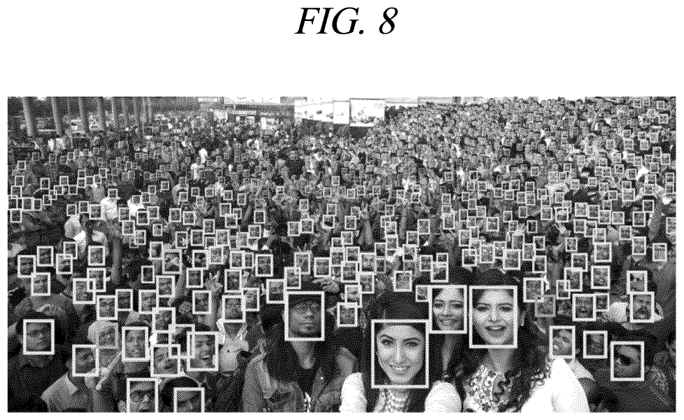

FIG. 8 is a diagram illustrating a face detection model for detecting the user's face in an image included in the imaging information and determining the location of the face.

The face detection model may be used in a similar way to the above-described object detection mode. Unlike the object detection model, which detects a specific object in an image, the face detection model may identify the location of a face in an image and generate a corresponding bounding box. As the face detection model, a CNN-based detection model may be applied, and object detection algorithms, such as RCNN, Fast RCNN, YOLO, Single Shot Detector (SSD), Retina-Net, and Pyramid Net, may be used.

Referring to FIG. 7, the face detection model extracts the location of at least one person's face in an image, and generates and outputs a bounding box. The bounding box generated by the face detection model may be used as input data for the identity recognition model, facial expression recognition model, and face orientation recognition model, which will be described later.

To improve the accuracy of the results, the user's height information previously input by the face detection model or the user's height information estimated by the pose estimation model may be input into the robot. Accordingly, the robot may rotate its camera up and down to accurately recognize a standing user's face, even from a close distance.

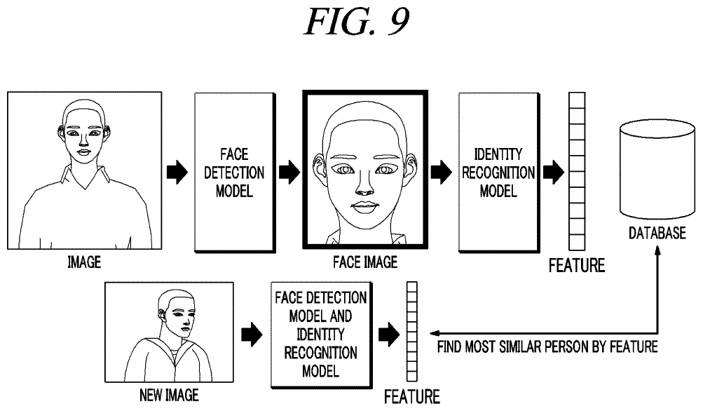

FIG. 9 is a diagram illustrating an identity recognition model for recognizing the user's identity from a face image generated based on the determined face location.

Feature points may be extracted from the image of the bounding box extracted by the identity recognition model and stored in the database, and the face of the tracking target may be identified by comparing the feature points extracted from the image of the bounding box with the feature points previously stored in the database. As the identity recognition model, a CNN-based model may be applied, and algorithms, such as VGG-Face, FaceNet, OpenFace, DeepFace, and ArcFace, may be used.

Referring to FIG. 9, the face detection model generates a bounding box around a person's face in an image to extract a face image, which is then input into the identity recognition model to extract its features. The extracted features are stored in the database. Thereafter, when a new image is input, features are extracted by applying the above-described face detection model and identity recognition model. The extracted features are compared and matched with the features stored in the database 119 to recognize the identity.

To improve the accuracy of the results, the identity recognition model may provide voice guidance to prompt the user to face the robot's camera. Accordingly, the robot may generate a front image of the user's face to recognize the user's identity more accurately. The face orientation recognition model, which will be described later, may confirm whether the user's face is facing the camera based on its result data.

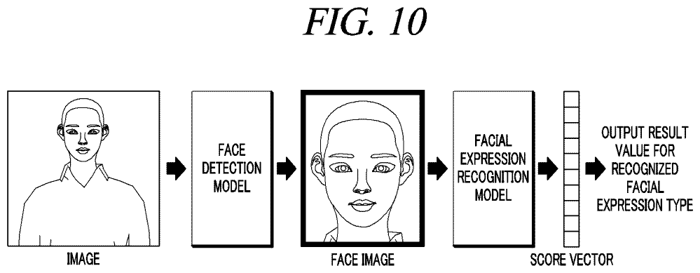

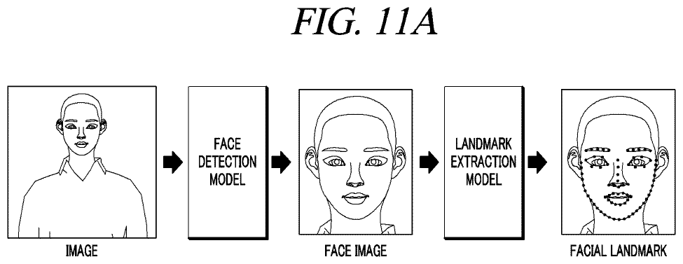

FIG. 10 is a diagram illustrating a facial expression recognition model for recognizing the user's facial expression from a face image generated based on the determined face location.

The facial expression recognition model may receive a face image that was extracted by the face detection model. The facial expression recognition model uses a CNN-based classification model to output scores for one or more predetermined facial expressions. The facial expression recognition model may determine the facial expression with the highest score as the final recognized facial expression. As the facial expression mode, one or more CNN architectures such as AlexNet, VGG-16, Inception, ResNet, and MobileNet may be used.

To improve accuracy, a model trained using facial expression data collected from a predetermined dataset may be used. Further, the user's facial expression data captured by the robot may be used when the facial expression recognition model is trained. To this end, the robot may provide voice guidance to prompt the user to make various facial expressions.

FIG. 11A to FIG. 11B are diagrams illustrating a face orientation recognition model for recognizing the orientation of the user's face from a face image generated based on the determined face location

When a face image extracted by the face detection model is input, the face orientation recognition model may extract facial landmarks. A convolutional neural network (CNN) may be used in this process. The face orientation recognition model may output the orientation of the face based on the positions of the eyes and nose as well as the facial contours.

Referring to FIG. 11A, the face detection model may generate a bounding box for a face image from an input image, and the face image is processed by the face orientation recognition model to extract facial landmarks. Referring to FIG. 11B the orientation of the face is output based on the extracted facial landmarks.

Referring back to FIG. 2, the derivation unit 113 may generate element information using the above-described analysis models. Herein, the element information may refer to information that includes result values output by each analysis model in response to the input data.

The element information generated by each analysis model may collectively form integrated information. That is, the integrated information may comprehensively store the values analyzed by the above-described analysis models. For example, from the integrated information composed of element information, it is possible to derive statements such as: “The user is in the living room,” “The user is moving their arms,” “The user has a neutral facial expression,” or “The user is looking forward.”

More specifically, element information and integrated information can be defined as follows. Among the element information, the user's location information may refer to the position of the user on an indoor map generated by the robot. The location information may be represented as two-dimensional coordinates based on a specific point on the map.

Among the element information, spatial information may refer to information for classifying the type of space the user is currently in, and may be derived by the space classification model. The spatial information may also include a probability value that the user is located in a specific space. For example, the spatial information may include data indicating that the user in a captured image is located in the living room with a probability of 90%.

Among the element information, object information may refer to information for classifying the type of object detected in the robot's field of view, and may be derived by the object detection model. The object information may include a probability value that the object in a captured image belongs to a specific category as well as a result value indicating whether the user is holding the object. For example, the object information may include data indicating that the object in the captured image is classified as a TV with a probability of 80%, and the user is not holding the TV. In another example, the object information may include data indicating that the object in the captured image is classified as a vacuum cleaner with a probability of 99%, and the user is holding the vacuum cleaner.

Among the element information, action information may refer to information for classifying the type of action the user is performing within the robot's field of view, and may be derived by the action recognition model. The action information may include a probability value that the user's action in a captured image belongs to a specific category. For example, the action information may include data indicating that the user in the captured image is moving their hand up and down with a probability of 80%, or bending over with a probability of 70%.

Among the element information, time information refers to information about the current time, and may be generated by the above-described collection device 111.

Among the element information, identity information refers to information for identifying the user detected in the robot's field of view, and may be derived by the identity recognition model. The identity information may include a probability value that the user in a captured image matches a certain identity, and personal information retrieved from the database 119 based on the identity. For example, the identity information may include data indicating that the user in the captured image is likely named Hong Gil-dong with a probability of 90% as well as personal information such as male gender and a diagnosis of Parkinson's disease.

Among the element information, facial expression information refers to information for classifying the user's facial expression detected in the robot's field of view, and may be derived by the facial expression recognition model. The facial expression information may include a probability value that the user's facial expression in a captured image belongs to a specific category. For example, the facial expression information may include data indicating that the user's facial expression in the captured image matches “joy”with a probability of 90%.

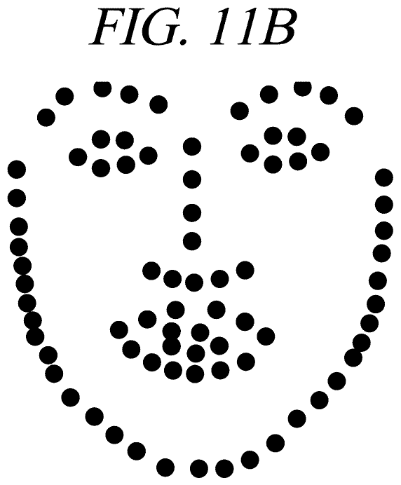

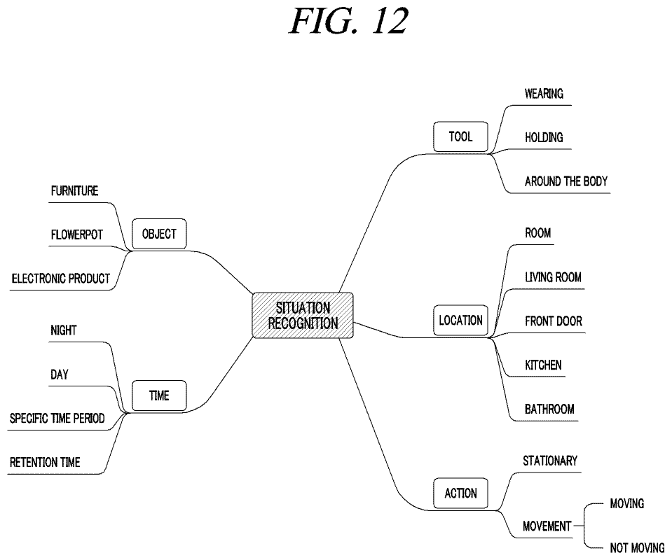

FIG. 12 is a diagram illustrating the process by which the situation recognition unit 114 of the customized service providing robot 100 recognizes the user's situation according to an embodiment of the present disclosure. Referring to FIG. 12, it can be seen that the situation recognition unit 114 recognizes the current situation based on various types of information included in the element information (e.g., A “furniture” is detected as an “object” near the user, the user is “wearing” a “tool,” or the user is “located” in the “living room”) and generates situation information corresponding thereto.

The situation recognition unit 114 may recognize the user's current situation based on the integrated information composed of the derived element information and generate situation information corresponding thereto. More specifically, the situation recognition unit 114 may generate situation information from the integrated information by using at least one of a machine learning model and a rule-based model.

Herein, the situation information may be generated from the element information to describe the user's current situation or action.

For example, based on integrated information including element information such as “the user is in the kitchen,” “the user's arm is moving,” and “food is detected near the user,” the situation information such as “the user is eating in the kitchen” may be generated. Also, based on integrated information including element information such as “the user is in the living room” and “the user's entire body is repeatedly moving”, situation information such as “the user is exercising in the living room” may be generated.

The situation information generated by the above-described method may be matched with the integrated information input into the situation recognition unit 114 and stored in the database 119.

If a designer predefines rules associated with situation information corresponding to element information, and element information matching one of the predefined rules is input, the rule-based model may generate situation information according to rule.

For example, if the element information indicates that the user is holding a vacuum cleaner and moving their arms, the situation recognition unit 114 may generate situation information indicating that the user is cleaning, according to the predefined rules.

Meanwhile, the machine learning model may be trained to output situation information by preprocessing the element information that composes the integrated information and inputting the processed data into an artificial neural network.

When the situation recognition unit 114 generates situation information using the machine learning model, it may store, in the database, the user's location, action, identity, and facial expression detected from the element information and then use them as training data. The element information may be input into the machine learning model and may undergo data preprocessing to vectorize the result values from each analysis model. The machine learning model may be trained through supervised learning to generate more accurate situation information.

Further, if the situation recognition unit 114 identifies a repeated pattern in the user's daily activities stored in the database 119, it may generate daily routine information using integrated information and situation information, and may generate more accurate situation information based on the daily routine information. For example, if the user is observed as having a tendency to eat after taking a shower on a daily or weekly basis, the situation recognition unit 114 may learn such a pattern to generate situation information corresponding to the user's mealtime.

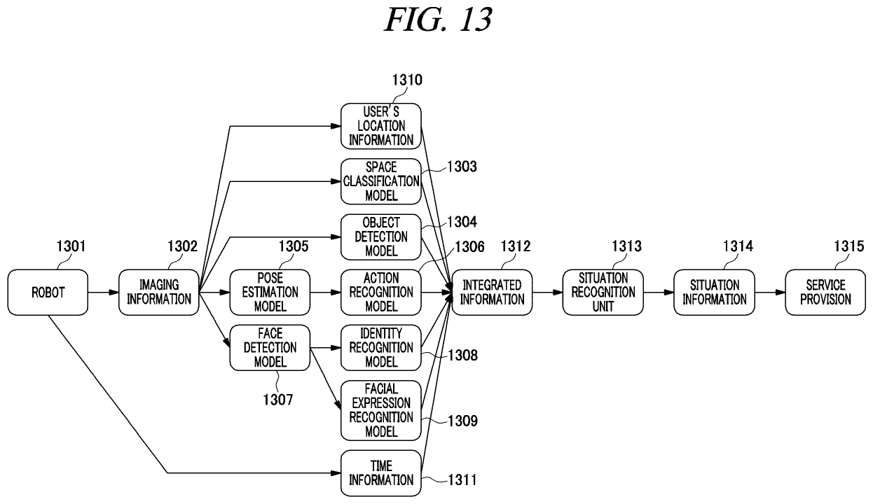

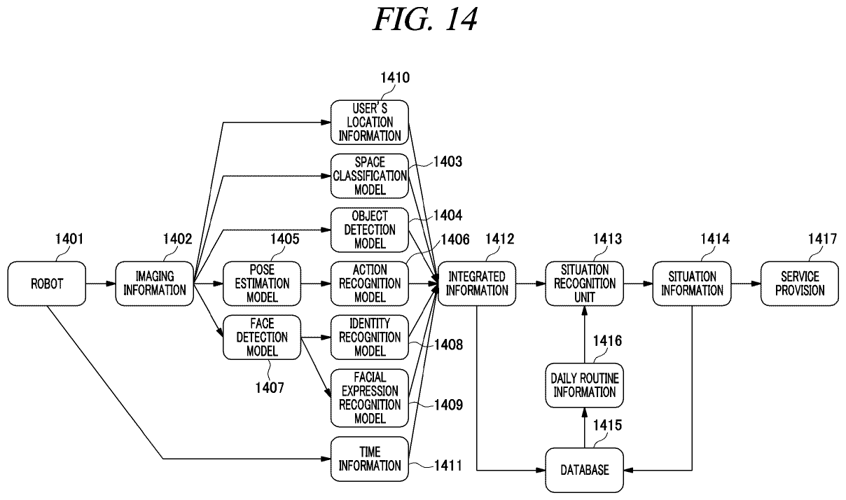

The process by which the situation recognition unit 114 generates situation information and the process by which the situation recognition unit 114 additionally uses daily routine information to generate such information will be described with reference to FIG. 13 and FIG. 14.

FIG. 13 is a diagram illustrating the provision of a customized service by the customized service providing robot according to an embodiment of the present disclosure.

Referring to FIG. 13, a customized service providing robot 1301 captures an image of the user and generates imaging information 1302. Then, the imaging information 1302 may be input into a space classification model 1303, an object detection model 1304, a pose estimation model 1305, an action recognition model 1306, a face detection model 1307, an identity recognition model 1308, and a facial expression recognition model 1309, and may be processed into element information that includes the result values from each analysis model.

Then, integrated information 1312 is generated by combining the element information, user's location information 1310, and time information 1311. Thereafter, the integrated information 1312 is input into a situation recognition unit 1313, which generates situation information 1314 regarding the current situation. Based on the situation information 1314, service provision 1315 is enabled.

FIG. 14 is a diagram illustrating the provision of a customized service by the customized service providing robot according to an embodiment of the present disclosure. FIG. 14, unlike FIG. 13, shows that additional daily routine information is generated from the information stored in the database.

Referring to FIG. 14, a customized service providing robot 1401 captures an image of the user and generates imaging information 1402. Then, the imaging information 1402 may be input into a space classification model 1403, an object detection model 1404, a pose estimation model 1405, an action recognition model 1406, a face detection model 1407, an identity recognition model 1408, and a facial expression recognition model 1409, and may be processed into element information that includes the result values from each analysis model.

Then, integrated information 1412 is generated by combining the element information, user's location information 1410, and time information 1411. Thereafter, the integrated information 1412 is input into a situation recognition unit 1413, which generates situation information 1414 regarding the current situation. The situation information 1414 and the integrated information 1412 are stored in a database 1415. Daily routine information 1416 patterning the user's daily routine may be generated from the information stored in the database 1415. The daily routine information 1416 may be input into the situation recognition unit 1413 together with the integrated information 1412 and used to generate the situation information 1414 more accurately. Then, based on the situation information 1414, service provision 1417 is enabled.

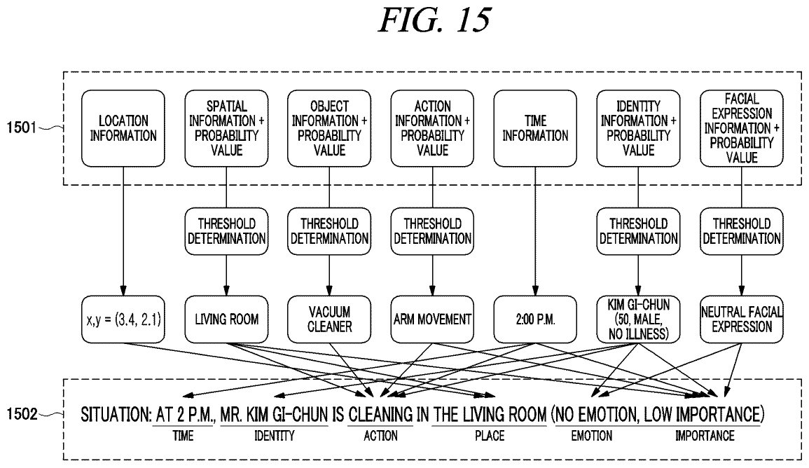

Hereinafter, the process by which the situation recognition unit 114 generates situation information by using at least one of the rule-based model and the machine learning model will be described in more detail with reference to FIG. 15 to FIG. 18.

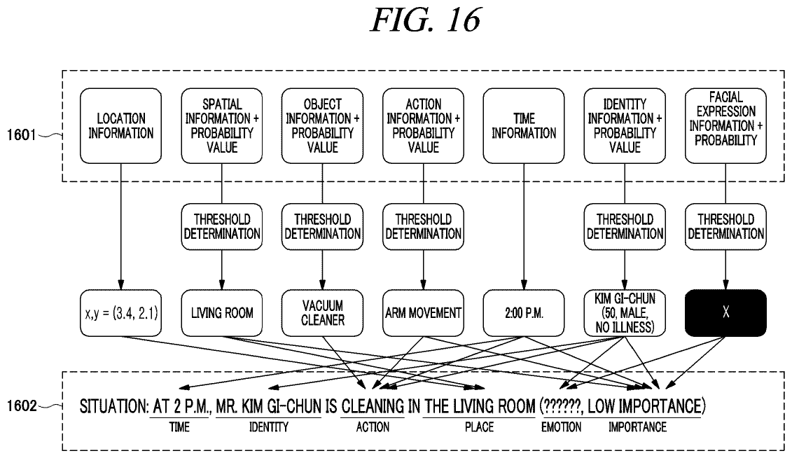

FIG. 15 and FIG. 16 are diagrams illustrating the generation of situation information by the situation recognition unit 114 based on the rule-based model according to an embodiment of the present disclosure.

The rule-based model may determine detailed elements of a situation (e.g., time, place, identity, action, emotion, and importance) based on predefined conditions using the element information. The situation recognition unit 114 may generate situation information using element information that has a probability value equal to or greater than a threshold set for each type of element information.

The situation information may include information about the current time, the user's location, identity, action and current emotion, and the importance of the current situation.

To compose the situation information, the situation recognition unit 114 may use a plurality of types of element information. For example, information about the user's action may be derived based on location information, object information, action information, and time information included in the element information. Further, the importance may be derived based on spatial information, action information, time information, identity information, and facial expression information included in the element information.

The rule-based model may be one in which a designer predefines element information used to compose the situation information along with rules associated with thresholds for each type of element information.

Referring to FIG. 15, various types of element information 1501, such as location information, spatial information, object information, action information, time information, identity information, and facial expression information, which composes the integrated information are input into the situation recognition unit 114. The situation recognition unit 114 determines whether a probability values included in the element information satisfies a corresponding threshold. Based on the element information that satisfies the threshold, the situation recognition unit 114 may derive that the user is located at coordinates x, y=3.4, 2.1, the type of place is a living room, a vacuum cleaner is detected nearby, the user's arms are moving, the current time is 2 p.m., the user's identity is Hong Gil-dong, a 50-year-old male with no illness, and the user has a neutral facial expression. Based on the derived information, the situation recognition unit 114 may generate situation information 1502 such as “At 2 p.m., Mr. Kim Gi-Chun is cleaning in the living room. The emotional state is neutral, and the situation is of low importance.” Herein, the arrows in the diagram indicate the types of element information used to generate each type of situation information (e.g., time, place, identity, action, emotion, and importance).

In cases where situation information is generated by using the rule-based model, if certain element information fails to satisfy threshold criteria, the element information may not be used to generate the situation information due to uncertainty. If too many types of element information fail to satisfy their threshold criteria, the situation information may not be generated. Even so, if service provision is still enabled, the situation recognition unit 114 may prompt the robot to provide the service. Meanwhile, if service provision is not enabled due to element information that fails to satisfy the threshold criteria, the situation recognition unit 114 may prompt the robot to obtain the necessary information from the user through voice chat or other communication methods. Alternatively, the situation recognition unit 114 may relax the threshold criteria for element information and use suboptimal results as information. Otherwise, the situation recognition unit 114 may use the user's daily routine information to generate situation information Unlike the case in FIG. 15, FIG. 16 illustrates an example in which a probability value of the facial expression information in element information 1601 fails to satisfy the threshold criteria. In this case, the situation recognition unit 114 cannot determine the user's facial expression. Therefore, the situation recognition unit 114 cannot generate information about the user's emotion to be included in the situation information.

The rule-based model can improve the accuracy of action recognition by applying different threshold criteria for each type of element information in each situation. The most crucial element of the situation information (e.g., time, place, identity, action, emotion, and importance) is the information about action. Therefore, different types of element information may be prioritized for different actions to improve the accuracy of action recognition. That is, since the types of element information obtainable from each action of the situation information vary, the elements to be used can be set differently for each action.

For example, if the user is holding a vacuum cleaner, situation information may be unconditionally generated to indicate that the user is cleaning. That is, if the action of cleaning is recognized, threshold criteria for object information may be adjusted to increase its importance. If the user is holding a vacuum cleaner at 2 p.m. in the living room or holding it at any other time while walking, situation information may be generated to indicate that the user is cleaning based on the element information indicating that the user is holding the vacuum cleaner. In this case, if the situation recognition unit 114 detects that the user is holding the vacuum cleaner based on the object information even when the other types of element information do not satisfy the threshold criteria, it may generate the user's situation information.

In another example, if the user is in bed during the time period from midnight to morning, the situation recognition unit 114 may generate situation information indicating that the user is sleeping. If the user is lying in bed at 2 a.m., the situation recognition unit 114 may generate situation information indicating that the user is sleeping based on time and location information even when action or emotion information does not satisfy the threshold criteria.

In yet another example, if the user is in the kitchen and water sounds are detected nearby, the situation recognition unit 114 may generate situation information indicating that the user is washing dishes even when the other types of element information do not satisfy the threshold criteria.

As described above, the situation recognition unit 114 may also use the user's daily routine information together with the integrated information to generate situation information. The daily routine information may be a list of situations likely to occur at the current time, arranged in descending order of probability (e.g., first: exercise, second: nap).

The situation recognition unit 114 may also generate daily routine information by listing situations in order of frequency during specific time periods (e.g., exercise 7 times, nap 5 times, and walk 4 times between 2 p.m. and 3 p.m. during the week).

The situation recognition unit 114 may generate daily routine information by listing situations in order of frequency at specific locations and times (e.g., exercise 7 times, watch TV 4 times, and play cognitive games 2 times in the living room at 2 p.m. during the week).

Further, the situation recognition unit 114 may generate daily routine information by calculating the frequency of one situation following another during specific time periods (e.g., shower 4 times, eat 2 times, walk 1 time after exercise during the week).

By adding the above-described daily routine information to the integrated information to generate situation information, the situation recognition unit 114 may improve the accuracy of situation recognition based on the situation information.

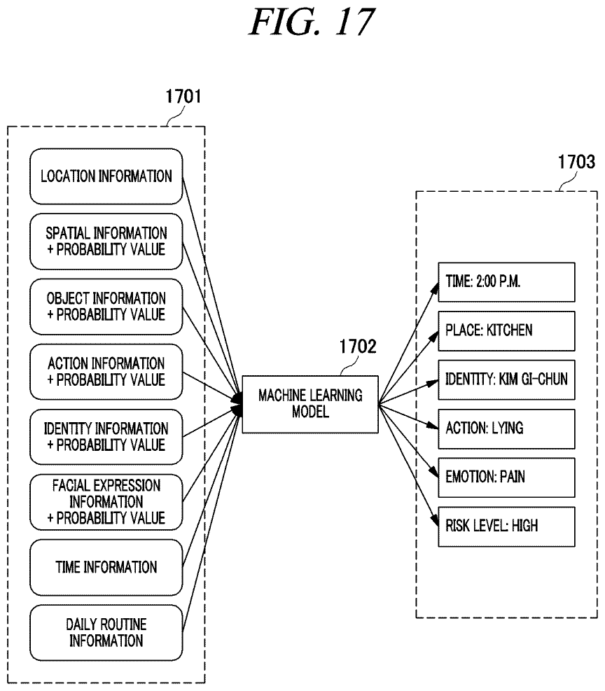

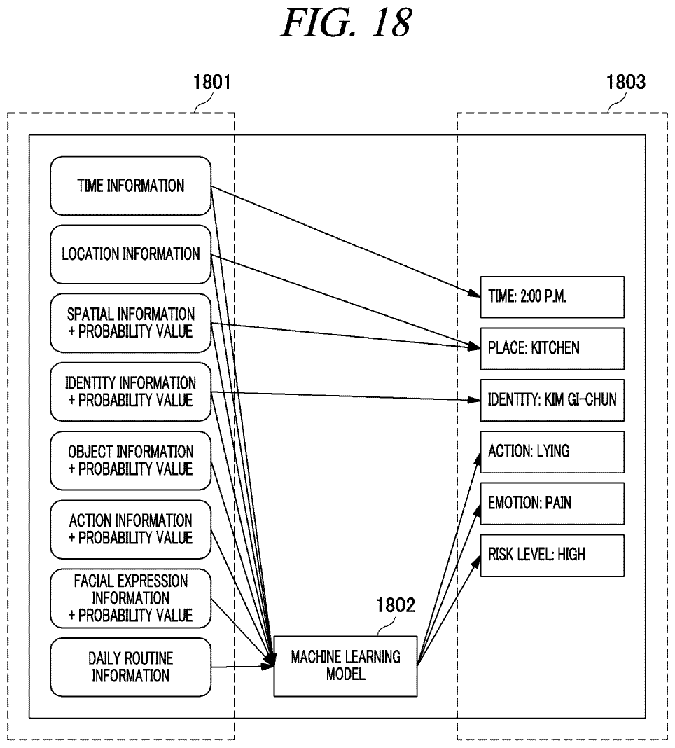

FIG. 17 and FIG. 18 are diagrams illustrating the generation of situation information by the situation recognition unit 114 based on the machine learning model according to an embodiment of the present disclosure.

The machine learning model may be trained using both the rules of the rule-based model and the situation information generated based on those rules. The training data for the machine learning model may be manually recorded by a designer or collected through the rule-based model. The element information input for training the machine learning model may include not only probability values, but also classification results included in spatial information, object information, action information, identity information, and facial expression information.

A machine learning-based model can be trained using weights that represent the importance or influence of each type of element information on the situation information, which eliminates the need to set threshold criteria for each type of element information as in the rule-based model. That is, training the machine learning-based model enables the automatic determination of which types of element information are important for each action.

Referring to FIG. 17, each element information item 1701 is input into a machine learning model 1702, and situation information 1703 is output from the machine learning model 1702. Referring to FIG. 18, although each element information item 1801 is input into a machine learning model 1802, the information related to time, location, and identity in the situation information is not generated using the output of the machine learning model, but is instead directly extracted from the time information, location information, spatial information, and identity information among the element information.

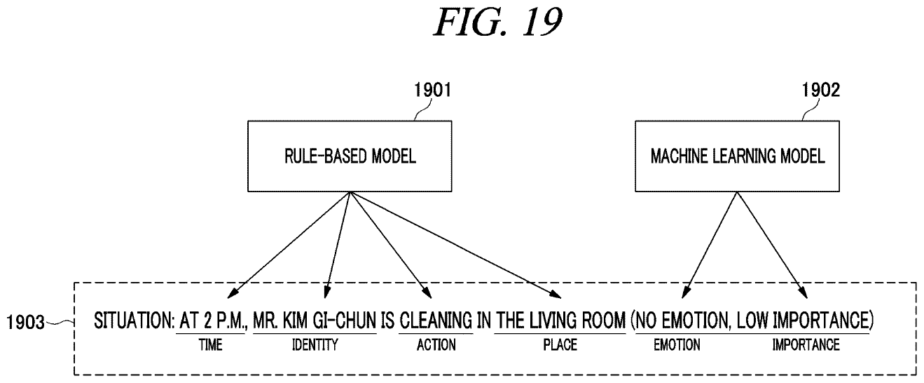

FIG. 19 is a diagram illustrating the generation of situation information by the situation recognition unit 114 based on both the rule-based model and the machine learning model according to an embodiment of the present disclosure.

The situation recognition unit 114 may generate situation information using either the rule-based model, the machine learning model, or both.

In a first embodiment, the situation recognition unit 114 uses both the rule-based model and the machine learning model to generate situation information, and when the results of the two models differ for specific detailed element information, it sets conditions to determine which model's result to use.

More specifically, for certain detailed element information that composes the situation information, such as time, place, identity, and emotion, the results of the rule-based model and the machine learning model may be the same. This is because, when the situation recognition unit 114 infers time, place, identity, and emotion from the detailed element information, it refers to the same element information (e.g., time information, location information, identity information, and facial expression information), resulting in no difference between the result values from the two models.

However, for other detailed element information in the situation (e.g., action information), the results of the rule-based model and the machine learning model may differ. Thus, the situation recognition unit 114 may set conditions to determine which model's result to use

Examples of such conditions may include threshold criteria. For example, in the case of the machine learning model, since the classification result and probability value can be derived for the action and its importance among the detailed element information of the situation information, it is possible to set a threshold criterion for the action information in the detailed element information so that it is used only when the probability value is higher than the threshold criterion, and when the probability value of the machine learning model is lower than the threshold criterion, the result of the rule-based model is used.

For example, when generating situation information using the rule-based model, the result may be: “At 2 p.m., Mr. Hong Gil-dong is cleaning in the living room (no emotion, medium importance).” Also, when using the machine learning model, the result may be: “At 2 p.m., Mr. Hong Gil-dong is walking around in the living room (no emotion, low importance).” In this case, the two models derive the same results for detailed element information regarding time, place, and identity, but derive different results for action and importance.

In the above-described example, when determining the action information among the detailed element information, the situation recognition unit 114 may obtain a probability value for the action (“walking around”) included in the situation information generated by the machine learning model. When the probability value is less than a predetermined threshold, the situation recognition unit 114 may employ the action (“cleaning”) included in the situation information generated by the rule-based model.

Likewise, in the above-described example, when determining the importance information among the detailed element information, the situation recognition unit 114 may obtain a probability value for the importance (“low importance”) included in the situation information generated by the machine learning model. When the probability value is greater a predetermined threshold, the situation recognition unit 114 may employ the result (“medium importance”) from the machine learning model instead of the result of the rule-based model. The situation information finally generated by the situation recognition unit 114 as described above may be “At 2 p.m., Mr. Hong Gil-dong is cleaning in the living room (no emotion, low importance).” In a second embodiment in which the situation recognition unit 114 generates situation information by using both the rule-based model and the machine learning model, each type of detailed element information composing the situation information may be preset to follow either the result of the rule-based model or the result of the machine learning model.

Referring to FIG. 19, information regarding time, place, identity, and action among detailed element information composing situation information 1903 follows the results of a rule-based model 1901, whereas information regarding emotion and importance follows the results of a machine learning model 1902.

Such setting criteria are merely exemplary, and each type of detailed element information of the situation information may be configured to follow the result of a different model according to the designer's intention.

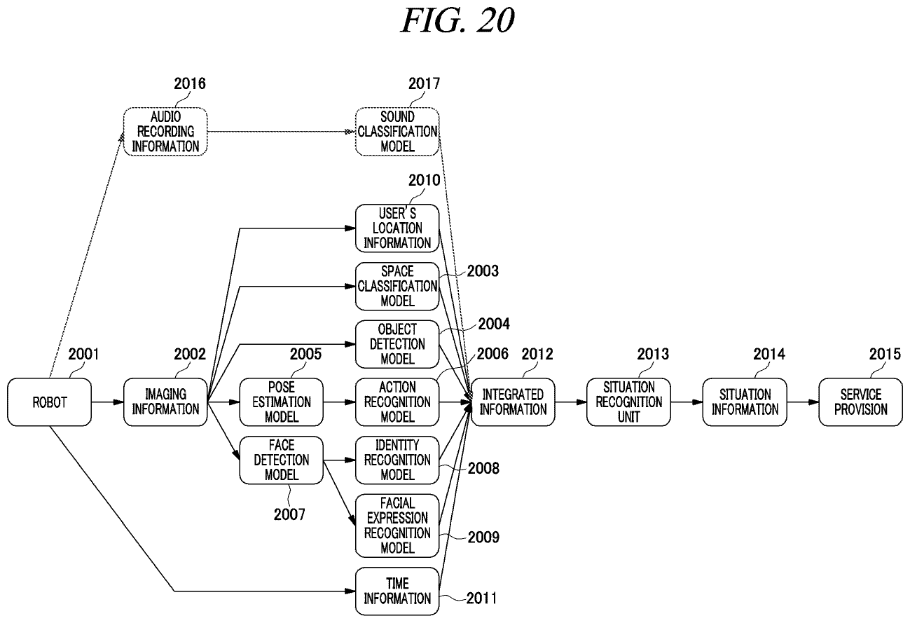

FIG. 20 is a diagram illustrating the provision of a customized service by the customized service providing robot according to an embodiment of the present disclosure.

Unlike the case in FIG. 13, FIG. 20 illustrates that sound information 2016 is generated from a robot 2001 and input into a sound classification model 2017, and the output of the sound classification model 2017 is included in integrated information 2012.

As described above, the robot 2001 may record sounds from the user or from the surroundings of the robot through a microphone included in the body unit. Then, the recorded sounds may be converted into digital data through a signal conversion process in the microphone. The sound information 2016 may have time-series waveform data and may be input into the sound classification model 2017. Then, the sound information 2016 may be analyzed by an AI algorithm for sound classification.

The sound classification model 2017 may perform frequency analysis using a feature extraction algorithm based on machine learning to measure the magnitude of a specific frequency band of the sound, or to extract energy or tone of the sound. Further, the sound classification model 2017 may apply a machine learning-based classification algorithm to classify sounds based on extracted features. This algorithm is typically implemented through supervised learning. That is, the sound classification model 2017 is trained using previously classified sound data to classify new sound data. Through the sound classification model 2017, it is possible to classify whether the sound currently input via the microphone is the user's voice, the sound of dishwashing, the user's breathing, or the sound of a vacuum cleaner. The type of sound and its probability value classified in this way may be generated as sound information, which is one type of element information. Then, the sound information may be integrated with other types of element information to be used as part of the integrated information 2012.

Subsequently, a situation recognition unit 2013 may generate situation information based on other types of element information and sound information. For example, if the situation recognition unit determines that the user is located in the kitchen and that water sounds are detected as the sound information, it may determine, as the action information of the situation information, that the user is washing dishes. In another example, if the situation recognition unit determines that the user is walking around and that vacuum cleaner sounds are detected as the sound information, it may determine, as the action information of the situation information, that the user is cleaning.

The situation recognition unit 114 may generate the situation information by considering not only the element information but also the above-described device information.

For example, when device information indicating that a smartphone carried by the user has suddenly fallen is received, the situation recognition unit 114 may generate situation information indicating an emergency situation, based on element information that the user is located in the bedroom and element information that the user has a facial expression of pain.

In another example, when a wake-up alarm signal from the smartphone carried by the user is received or when movement of the smartphone of the user in a sleep state is detected, the situation recognition unit 114 may generate situation information indicating that the user has awakened from sleep.

The service providing unit 115 may control the robot to provide a customized service to the user based on the situation information. More specifically, the service providing unit 115 may control a customized service providing robot to provide at least one of a service for outputting an image based on the situation information, a service for outputting a voice based on the situation information, and a service for making an emergency call to a predetermined device based on the situation information.

The service providing unit 115 may provide an appropriate service to the user by using various output devices provided in the body unit 110 of the customized service providing robot 100. For example, the service providing unit 115 may play back media content through the display 116, and output voice related to the played content or provide voice guidance through the speaker 117. Further, the service providing unit 115 may transmit a wireless signal to another end device, a router hub, or a server through the communication device 118.

Examples of services provided by the service providing unit 115 based on the situation information are as follows.

When the user is having a meal in the kitchen, the service providing unit 115 may control the speaker to play back songs or videos. When the user is exercising in the living room, the service providing unit 115 may control the speaker or the display to play back songs or videos. When the user is cooking or washing dishes in the kitchen, the service providing unit 115 may control the speaker or the display to play back songs or videos.

When the user has been sitting on the sofa for a long time, the service providing unit 115 may control the speaker to output voice guidance recommending exercise or a walk, or display related text.

When the user has not moved for a long time in one place, the service providing unit 115 may control the speaker to provide voice guidance encouraging movement, or display related text.

When the user sitting on the sofa has a depressed facial expression, the service providing unit 115 may execute emotion management content. At the user's medication time, the service providing unit 115 may approach the user and output a medication-time alarm through the speaker, observe the user's action thereafter to determine whether the user has completed the medication, and store the related information in the database or notify the server through the communication device 118.

When the user is lying in a fall risk area, the service providing unit 115 may control the customized service providing robot to output a fall warning. The service providing unit 115 may also check the facial expression or action of the fallen user and, if it determines that the user is unconscious, may transmit a signal to a guardian's end device or to a predetermined emergency rescue agency through the communication device 118.

When the user is lying in a location where the user does not normally lie down, the service providing unit 115 may check the user's facial expression or action and, if it determines that the user is unconscious, may transmit a signal to a guardian's end device or a predetermined emergency rescue agency through the communication device 118.

When the user gets out of bed in the morning, the service providing unit 115 may notify the user of the day's schedule. When it is determined that the user has not exited a location inaccessible to the robot (e.g., a closed bathroom) for a predetermined period of time or at a time pattern different from usual, the service providing unit 115 may check the current situation through voice guidance, and depending on the user's response thereafter, an emergency call may be made.

When the user performs repetitive action in a specific location, the service providing unit 115 may provide voice guidance to check the user's situation, and when it is determined to be an emergency or when a departure from the living space is detected according to user settings, an emergency call may be made.

When the indoor movement (e.g., gait pattern) recognized using vision recognition information is clearly different from normal, the service providing unit 115 may control the customized service providing robot to perform confirmation and provide a warning notification to the user, and to make an emergency call if necessary.

Further, the service providing unit 115 may control the customized service providing robot to perform an interaction process with the user based on situation recognition information. For example, when the customized service providing robot 100 determines the user's emotion based on the generated situation information, the customized service providing robot 100 may induce the user to interact with it by outputting motion, voice, or video corresponding to the user's emotion. When it is detected that the user responds with voice, facial expression, or action to the motion, voice, screen, or video output of the customized service providing robot 100, new situation information may be generated to enable additional customized service provision.

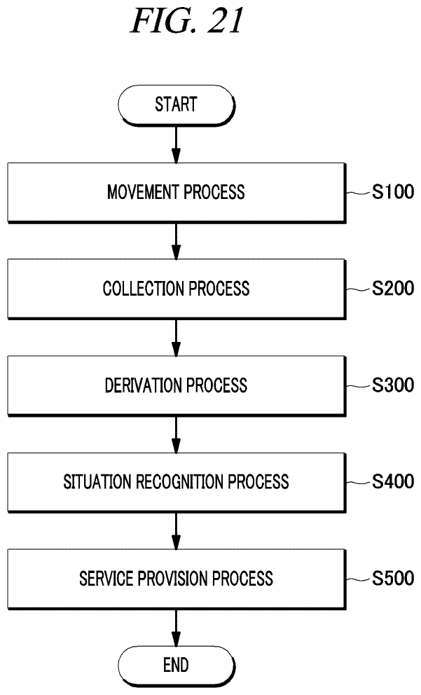

FIG. 21 is a flowchart showing a method for providing a customized service according to an embodiment of the present disclosure.

Referring to FIG. 21, the customized service providing method according to an embodiment of the present disclosure is a method for providing a customized service to a user using a robot, and may include: a movement process S100 of controlling a moving device to move to a location where the user is recognized; a collection process S200 of collecting imaging information related to the user through a visual sensor; an analysis process S300 of inputting the imaging information into at least one analysis model and deriving element information for each analysis model; a situation recognition process S400 of integrating the element information derived for each analysis model to generate integrated information and recognizing the user's current situation based on the integrated information to generate situation information; and a service provision process S500 of providing the customized service to the user based on the situation information.

The collection process S100 may further include a process of collecting at least one of time information for the capture of the imaging information, robot location information generated by recognizing the location of the robot through a location sensor, sound information generated by recognizing the user's voice or surrounding sounds through a sound sensor, and device information generated from another smart device.

Further, the device information may be generated by the smart device by detecting a location of the smart device, and the robot may move to a location where the user is located through the moving device based on the device information.

Meanwhile, the device information may be generated by the smart device by detecting a movement of the smart device, and the situation recognition process S400 may include a process of generating the situation information based on the element information and the device information.

The analysis model may include at least one of a space classification model for determining the type of space in an image included in the imaging information, an object detection model for determining the location and type of an object in an image included in the imaging information, and an action recognition model for determining the user's pose in an image included in the imaging information.

In the situation recognition process S400, the user's current situation may be recognized using a machine learning model or a rule-based model to generate the situation information. If there is element information corresponding to the rule-based model, the situation information may be generated by applying the rule-based model. If there is no element information corresponding to the rule-based model, the situation information may be generated by applying the machine learning model.

The service provision process S500 may include a process of providing at least one of: a service for outputting an image based on the situation information, a service for outputting a voice based on the situation information, and a service for making an emergency call to a predetermined device based on the situation information.

The method for providing a customized service may be divided into additional processes or combined into fewer processes according to the embodiments described above with reference to FIG. 1 to FIG. 13. In addition, some of the processes may be omitted and the sequence of the processes may be changed if necessary.

The method for providing a customized service can be implemented as a computer program stored in a computer-readable storage medium to be executed by a computer or a recording medium including instructions executable by a computer. Also, the method for providing a customized service can be implemented as a computer program stored in a computer-readable storage medium to be executed by a computer.

The above description of the present disclosure is provided for the purpose of illustration, and it would be understood by a person with ordinary skill in the art that various changes and modifications may be made without changing technical conception and essential features of the present disclosure. Thus, it is clear that the above-described examples are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim

1. A robot for providing customized service to a user, comprising:
a moving device configured to move the robot to a location where a user is recognized;
a collection device configured to capture an image of the user through a visual sensor and collect imaging information; and
a processor configured to process the information collected by the collection device and control the moving device,
wherein the processor inputs the information collected through the collection device into at least one pre-trained analysis model to derive element information for each analysis model (a),
integrates the derived element information for each analysis model to generate integrated information and recognizes the user's current situation based on the integrated information to generate situation information (b), and
controls the robot to provide a customized service to the user based on the situation information (c).

2. The customized service providing robot of claim 1,
wherein the collection device further includes at least one of a location sensor and a sound sensor, and
the collection device further collects at least one of time information for the capture of the imaging information, robot location information generated by recognizing the location of the robot through a location sensor, sound information generated by recognizing the user's voice or surrounding sounds through a sound sensor, and device information generated from another smart device.

3. The customized service providing robot of claim 2,
wherein the device information is generated by the smart device by detecting a location of the smart device, and
the robot moves to a location where the user is located through the moving device based on the device information.

4. The customized service providing robot of claim 2,
wherein the device information is generated by the smart device by detecting a movement of the smart device, and
the processor generates the situation information based on the element information and the device information.

5. The customized service providing robot of claim 1,
wherein the analysis model includes at least one of a space classification model for determining the type of space in an image included in the imaging information, an object detection model for determining the location and type of an object in an image included in the imaging information, and an action recognition model for determining the user's pose in an image included in the imaging information.

6. The customized service providing robot of claim 1,
wherein the analysis model includes a face detection model for detecting the user's face in an image included in the imaging information and determining the location of the face, and
the analysis model includes at least one of an identity recognition model for recognizing the user's identity from a face image generated based on the determined location of the face, a facial expression recognition model for recognizing the user's facial expression from a face image generated based on the determined location of the face, and a face orientation recognition model for recognizing the user's face orientation from a face image generated based on the determined location of the face.

7. The customized service providing robot of claim 1,
wherein the processor is configured to generate daily routine information regarding the user's repeated routine from a database that stores the integrated information and the situation information generated corresponding to the integrated information, and to generate situation information regarding the user's current situation based on the integrated information and the daily routine information.

8. The customized service providing robot of claim 1,
wherein the processor generates the situation information using at least one of a rule-based model configured to determine the user's current situation based on whether the element information derived from each analysis model satisfies a predetermined condition, and
a machine learning model configured to be trained using predetermined data and to predict situation information from the input integrated information.

9. The customized service providing robot of claim 8,
wherein the rule-based model determines the user's current situation based on a predetermined threshold condition and importance determined for each type of element information.

10. The customized service providing robot of claim 8,
wherein the machine learning model is trained using the integrated information, the condition used in the rule-based model, daily routine information regarding the user's repeated routine, and the generated situation information.

11. The customized service providing robot of claim 8,
wherein the processor is configured to generate the situation information using the rule-based model and the machine learning model,
compare the situation information generated by the rule-based model with the situation information generated by the machine learning model, and
when results from the models differ, selectively use the result from the rule-based model if a probability value for the result from the machine learning model is not greater than a predetermined threshold, and otherwise use the result from the machine learning model.

12. The customized service providing robot of claim 8,
wherein the processor is configured to generate the situation information using the rule-based model and the machine learning model, and
at least some of detailed element information which composes the situation information is based on a result of the rule-based model, and the rest is based on a result of the machine learning model.

13. The customized service providing robot of claim 1,
wherein the processor controls the robot to provide at least one of a service for outputting an image based on the situation information, a service for outputting a voice based on the situation information, and a service for making an emergency call to a predetermined device based on the situation information.

14. A method for providing a customized service to a user using a robot, comprising,
a movement process of controlling a moving device to move to a location where the user is recognized;
a collection process of capturing an image of the user and collecting imaging information through a visual sensor;
an analysis process of inputting the information collected by a collection device into at least one pre-trained analysis model and deriving element information for each analysis model;
a situation recognition process of integrating the element information derived for each analysis model to generate integrated information and recognizing the user's current situation based on the integrated information to generate situation information; and
a service provision process of controlling the robot to provide the customized service to the user based on the situation information.

15. The method for providing a customized service of claim 14,
wherein the collection device further includes at least one of a location sensor and a sound sensor, and
the collection process further includes a process of collecting at least one of time information for the capture of the imaging information, robot location information generated by recognizing the location of the robot through the location sensor, sound information generated by recognizing the user's voice or surrounding sounds through the sound sensor, and device information generated from another smart device.

16. The method for providing a customized service of claim 14,
wherein the device information is generated by the smart device by detecting a location of the smart device, and
the robot moves to a location where the user is located through the moving device based on the device information.

17. The method for providing a customized service of claim 14,
wherein the device information is generated by the smart device by detecting a movement of the smart device, and
the situation recognition process includes a process of generating the situation information based on the element information and the device information.

18. The method for providing a customized service of claim 14,
wherein the analysis model includes at least one of a space classification model for determining the type of space in an image included in the imaging information, an object detection model for determining the location and type of an object in an image included in the imaging information, and an action recognition model for determining the user's pose in an image included in the imaging information.

19. The method for providing a customized service of claim 14,
wherein the analysis model includes a face detection model for detecting the user's face in an image included in the imaging information and determining the location of the face, and
the analysis model includes at least one of an identity recognition model for recognizing the user's identity from a face image generated based on the determined location of the face, a facial expression recognition model for recognizing the user's facial expression from a face image generated based on the determined location of the face, and a face orientation recognition model for recognizing the user's face orientation from a face image generated based on the determined location of the face.

20. The method for providing a customized service of claim 14,
wherein the situation recognition process includes a process of generating the situation information using at least one of a rule-based model configured to determine the user's current situation based on whether the element information derived from each analysis model satisfies a predetermined condition, and
a machine learning model configured to be trained using predetermined data and to predict situation information from the input integrated information.
